(19) United States
(12) Patent Application Publication
(10) Pub. No.: US 2012/0044865 A1
(43) Pub. Date: Feb. 23, 2012

(54) Apparatus And Method For Coupling An M2M Device To A Wireless Network

(75) Inventors: Shubhranshu Singh, Raman Nagar Bangalore (IN); Jen-Shun Yang, Zhubei City (TW); Kuei-Li Huang, Kaohsiung City (TW); Jui-Tang Wang, Keelung City (TW); Gleixner Stephen, Zhubei City (TW)

(73) Assignee: Industrial Technology Research Institute

(21) Appl. No.: 13/184,287

(22) Filed: Jul. 15, 2011

Related U.S. Application Data
(60) Provisional application No. 61/375,506, filed on Aug. 20, 2010.

(51) Int. Cl. H04W 92/00

(52) U.S. Cl. 370/328

(57) ABSTRACT

Apparatus for coupling one or more machine-to-machine (M2M) devices to a wireless network, including: a first network interface controller (NIC) module configured to communicate with the M2M devices; an M2M controller unit coupled to the first NIC module, the M2M controller unit including a database and a controller, the controller being configured to store information regarding the M2M devices in the database and to retrieve information regarding the M2M devices from the database; and a second NIC module coupled to the M2M controller unit, the second NIC module including an M2M enable unit configured to send the information retrieved by the controller to the wireless network.

### RELATED APPLICATIONS

This application is based upon and claims the benefit of priority from U.S. Provisional Patent Application No. 61/375,506, filed Aug. 20, 2010, the entire contents of which are incorporated herein by reference.

### TECHNICAL FIELD

This disclosure relates to apparatus and method for coupling a machine-to-machine (M2M) device to a wireless network operating in accordance with a communication standard.

### BACKGROUND

A machine-to-machine (M2M) system, also known as a machine-type-communication (MTC) system, is a communication system that enables a flow of data, e.g., monitored data, from machine to machine and/or from machine to human with minimal human interaction. An example of the M2M system is a security system or a surveillance system.

FIG. 1 illustrates a block diagram of a conventional M2M system 100. Referring to FIG. 1, the system 100 includes one or more M2M devices 102, an M2M server 104, and a wireless network 106 provided by a service provider that may cover a large number of M2M devices. The M2M devices 102 may be used in different applications including, e.g., electricity, water, or gas consumption monitoring, remote health monitoring, etc. The M2M devices 102 are configured to send monitored data through the wireless network 106 to the M2M server 104 for further processing or analysis.

Typically, the wireless network 106 operates in accordance with a wireless communication standard, such as a 3rd Generation Partnership Project (3GPP) standard. Currently, however, the wireless network 106 configured to operate in accordance with the 3GPP standard may communicate with those M2M devices that are directly connected using a 3GPP interface.

### SUMMARY

According to a first aspect of the present disclosure, there is provided apparatus for coupling one or more machine-to-machine (M2M) devices to a wireless network, comprising: a first network interface controller (NIC) module configured to communicate with the M2M devices; an M2M controller unit coupled to the first NIC module, the M2M controller unit including a database and a controller, the controller being configured to store information regarding the M2M devices in the database and to retrieve information regarding the M2M devices from the database; and a second NIC module coupled to the M2M controller unit, the second NIC module including an M2M enable unit configured to send the information retrieved by the controller to the wireless network.

According to a second aspect of the present disclosure, there is provided a method for a gateway to couple one or more machine-to-machine (M2M) devices to a wireless network, comprising: communicating with the M2M devices; storing information regarding the M2M devices in a database and retrieving information regarding the M2M devices from the database; and sending the retrieved information to the wireless network.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments consistent with the invention and, together with the description, serve to explain the principles of the invention.

FIG. 1 illustrates a block diagram of a conventional machine-to-machine (M2M) system.

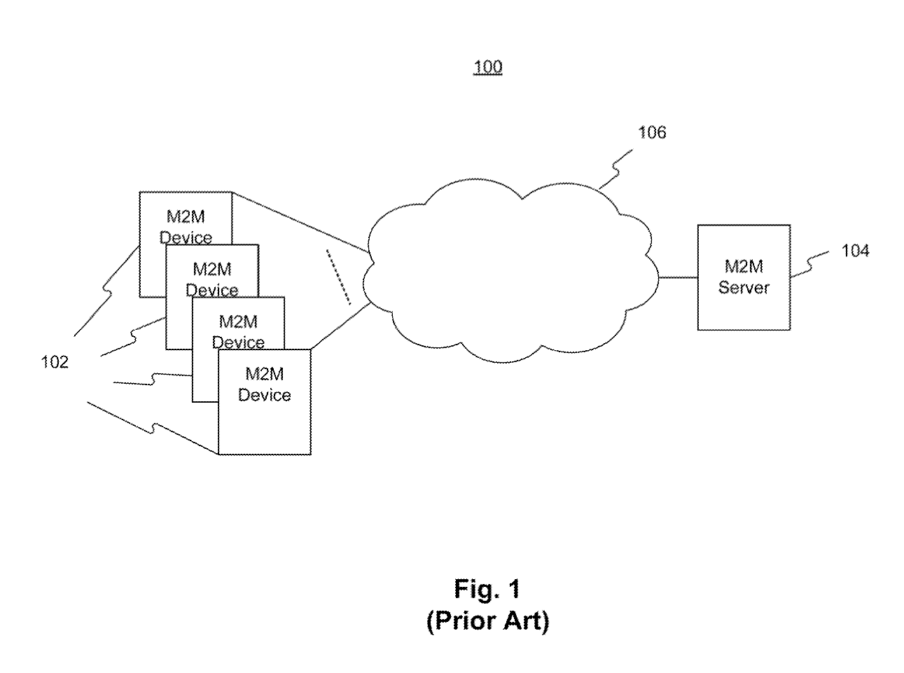

FIG. 2A illustrates a block diagram of an M2M system, according to an exemplary embodiment.

FIG. 2B illustrates a block diagram of an M2M gateway, according to an exemplary embodiment.

FIG. 3 illustrates a process for an M2M gateway to send initial information regarding M2M devices to a 3GPP network, according to an exemplary embodiment.

FIG. 4 shows a flowchart of a method for an M2M controller unit to provide updated information regarding M2M devices to a 3GPP network interface controller module in an M2M gateway, according to an exemplary embodiment.

FIG. 5 shows a flowchart of a decision making process performed by an M2M enable unit in an M2M gateway, according to an exemplary embodiment.

FIG. 6 illustrates a process for an M2M gateway to decide on sending updated information regarding M2M devices to a 3GPP network, according to an exemplary embodiment.

FIG. 7 illustrates a process for an M2M gateway to decide on sending updated information regarding M2M devices to a 3GPP network, according to an exemplary embodiment.

FIG. 8 illustrates a process for an M2M gateway to decide on sending updated information regarding M2M devices to a 3GPP network, according to an exemplary embodiment.

FIG. 9 illustrates a process for an M2M gateway to send updated information regarding M2M devices to a 3GPP network, according to an exemplary embodiment.

### DESCRIPTION OF THE EMBODIMENTS

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of systems and methods consistent with aspects related to the invention as recited in the appended claims.

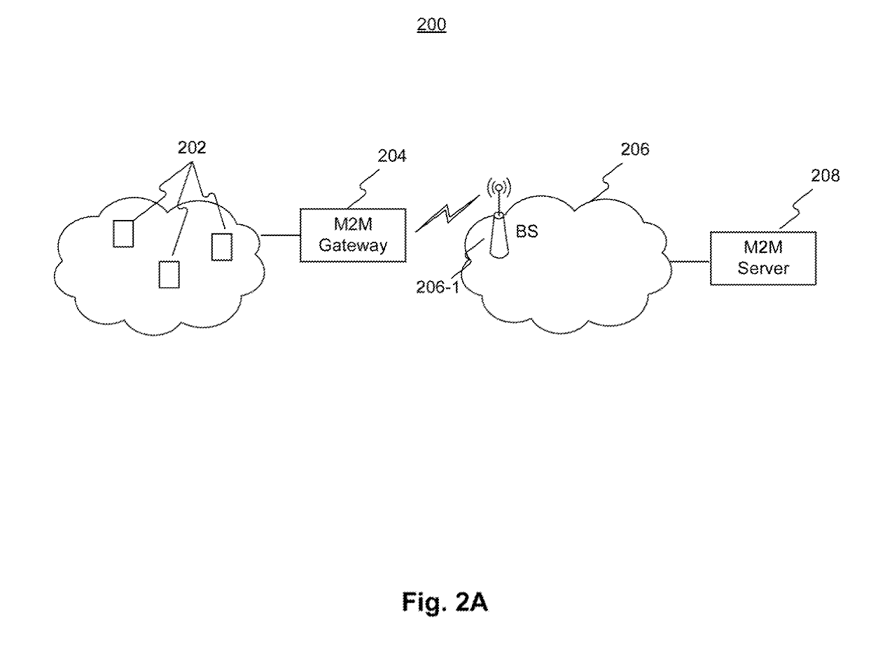

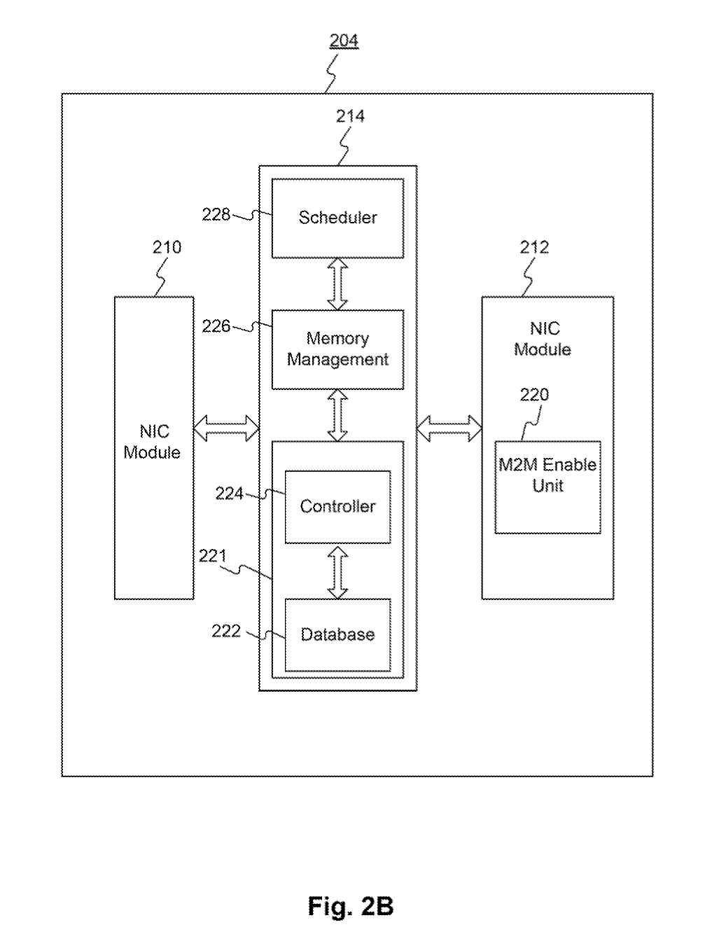

FIG. 2A illustrates a block diagram of a machine-to-machine (M2M) system 200, according to an exemplary embodiment. Referring to FIG. 2A, the system 200 includes one or more M2M devices 202, an M2M gateway 204, a wireless network 206 operating in accordance with a communication standard, and at least one M2M server 208. For illustrative purposes, it is assumed that the wireless network 206 operates in accordance with the 3rd Generation Partnership Project (3GPP) standard, and is therefore a 3GPP network.

In exemplary embodiments, the M2M devices 202 may each be a monitoring device for monitoring data to be sent to the M2M server 208 for further processing or analysis. The M2M devices 202 may be used in different applications including, e.g., electricity, water, or gas consumption monitoring, remote health monitoring, etc. In addition, the M2M devices 202 may be grouped as one or more groups of M2M devices based on common features, locations, etc., which may allow the M2M devices 202 to share common subscription with the 3GPP network 206. The M2M devices 202 may each be connected to the M2M gateway 204 through a wired interface, or a wireless interface, such as a WiFi interface, a Bluetooth interface, a Zigbee interface, a radio-frequency identification (RFID) interface, etc.

In exemplary embodiments, the M2M gateway 204 is configured to couple the M2M devices 202 to the 3GPP network 206. The M2M gateway 204 may include one or more of the following components: a processor configured to execute computer program instructions to perform various processes and methods disclosed herein, random access memory (RAM) and read only memory (ROM) configured to access and store information and computer program instructions, storage to store data and information, databases to store tables, lists, or other data structures, I/O devices, network interfaces, antennas, etc. Further detail of the M2M gateway 204 will be described below.

In exemplary embodiments, the 3GPP network 206 is a wireless communication network provided by a service provider that operates in accordance with the 3GPP standard. For example, the 3GPP network 206 includes at least one base station (BS) 206-1, also known as the eNodeB. When the M2M gateway 204 is located within a coverage area of the base station 206-1, the base station 206-1 may communicate with the M2M gateway 204. In addition, the base station 206-1 may also communicate with user terminals (not shown) located in the 3GPP network 206.

In exemplary embodiments, the 3GPP network 206 may also include the following components (not shown): a new mobility management entity (MME) that the M2M gateway 204 is to communicate with, an old MME or serving GPRS Support Node (SGSN) that the M2M gateway 204 previously communicated with, a serving gateway (GW), a packet data network (PDN) GW, a policy and charging rules function (PCRF), and a home subscriber server (HSS). Each of these components is defined in the 3GPP standard and will not be explained further.

In exemplary embodiments, the M2M server 208 is configured to communicate with the 3GPP network 206. For example, the M2M server 208 may receive monitored data from the M2M devices 202 through the 3GPP network 206. Also for example, the M2M server 208 may send control information to the M2M devices 202 through the 3GPP network 206.

FIG. 2B illustrates a block diagram of the M2M gateway 204 (FIG. 2A), according to an exemplary embodiment. Referring to FIGS. 2A and 2B, the M2M gateway 204 includes a non-3GPP network interface controller (NIC) module 210 for communicating with the M2M devices 202, a 3GPP NIC module 212 for communicating with the 3GPP network 206, and a core module 214 coupled to the non-3GPP NIC module 210 and the 3GPP NIC module 212. Each of the non-3GPP NIC module 210, the 3GPP NIC module 212, and the core module 214 may be implemented with hardware and/or software.

In exemplary embodiments, the non-3GPP NIC module 210 is configured to communicate with the M2M devices 202 using one or more non-3GPP interfaces, such as a WiFi interface, a Bluetooth interface, a Zigbee interface, and an RFID interface.

In exemplary embodiments, the core module 214 includes an M2M controller unit 221, which further includes a database 222 and a controller 224. The controller 224 stores information regarding the M2M devices 202 in the database 222 and retrieves information regarding the M2M devices 202 from the database 222. The core module 214 also includes a memory manager 226 to manage memory usage by the database 222, and a communication scheduler 228 to schedule communications between the M2M gateway 204 and the M2M devices 202 and communications between the M2M gateway 204 and the 3GPP network 206.

In exemplary embodiments, the 3GPP NIC module 212 includes, apart from a standard 3GPP protocol stack, an M2M enable unit 220 configured to enable control and monitoring of the M2M devices 202 through the 3GPP network 206. For example, the M2M enable unit 220 may send initial information regarding the M2M devices 202 to the 3GPP network 206 based on, e.g., as part of, an initial attach process provided in the 3GPP standard. Also for example, the M2M enable unit 220 may send, periodically or non-periodically, updated information regarding the M2M devices 202 to the 3GPP network 206 based on a Tracking Area Update (TAU) process provided in the 3GPP standard. As a result, the M2M gateway 204 enables the 3GPP network 206 to manage and monitor non-3GPP M2M devices and to update an MME database of the 3GPP network 206 with the initial or updated information regarding the M2M devices 202, as described in detail below.

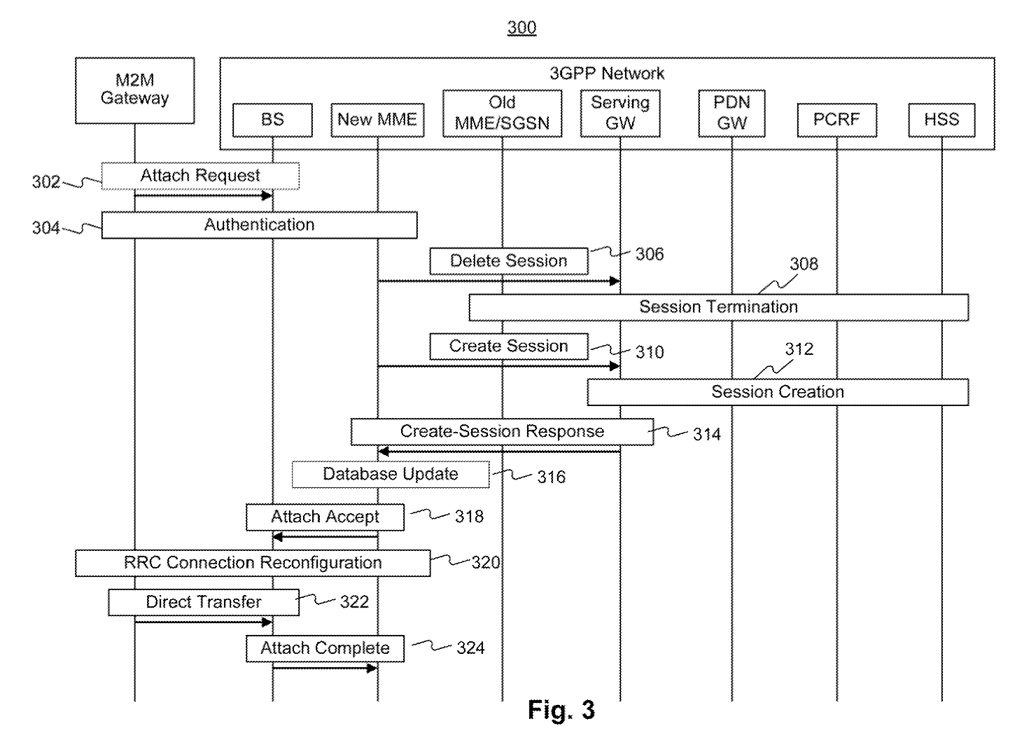

FIG. 3 illustrates a process 300 for the M2M gateway 204 (FIG. 2A) to send initial information regarding the M2M devices 202 (FIG. 2A) to the 3GPP network 206 (FIG. 2A), according to an exemplary embodiment. Referring to FIGS. 2A and 3, during the process 300, the M2M gateway 204 registers with the 3GPP network 206. In the exemplary embodiment, the process 300 is based on an initial attach process provided in the 3GPP standard.

As described above, the 3GPP network 206 may include the base station (BS) 206-1, the new MME, the old MME/SGSN, the serving GW, the PDN GW, the PCRF, and the HSS. The M2M enable unit 220 (FIG. 2B) in the M2M gateway 204 initiates the process 300 by sending an attach request to the base station 206-1 (302). The attach request includes initial information regarding the M2M devices 202, e.g., one or more group identifications for the M2M devices 202 as one or more groups, respectively, a number of the M2M devices 202 in each of the groups and/or connected to the M2M gateway 204, a list of individual identifications of the respective M2M devices 202, and/or M2M features. For example, the M2M features may be low volume data transmission or low mobility M2M monitoring.

Next, the new MME performs authentication of the M2M gateway 204 (304), and sends a delete-session request to the serving GW, to terminate any previous communication session between the M2M gateway 204 and the old MME/SGSN (306). As a result, the previous communication session is terminated, and the PDN GW indicates to the PCRF that resources for the previous communication session have been released (308).

The new MME further sends a create-session request to the serving GW (310). In response, the serving GW creates a new communication session for the M2M gateway 204, working together with the PDN GW, the PCRF, and/or the HSS (312). The serving GW also sends a create-session response to the new MME to indicate the creation of the new communication session (314).

The new MME then updates its database to include the initial information regarding the M2M devices 202 (316), and sends an attach-accept message to the base station 206-1 (318). The base station 206-1 then reconfigures the M2M gateway 204 by sending a radio resource control (RRC) connection reconfiguration message, which includes the attach-accept message, to the M2M gateway 204 (320). When the reconfiguration is finished, the M2M gateway 204 sends a direct-transfer message to the base station 206-1, to indicate that the attach process is completed (322). The base station 206-1 further sends an attach-complete message to notify the new MME (324). As a result, the M2M gateway 204 enables the 3GPP network 206 to update its MME database with the initial information regarding the M2M devices 202, and establishes communications with the 3GPP network 206.

Referring to FIG. 2A, in exemplary embodiments, a status of the M2M devices 202 may change. For example, the status change may include a new M2M device being added into the M2M devices 202, or an existing M2M device being removed from the M2M devices 202. Also for example, the status change may include any one of the M2M devices 202 changing its operation mode, e.g., changing from an idle mode to a power saving mode.

In exemplary embodiments, the M2M gateway 204 may obtain updated information regarding the M2M devices 202 through the non-3GPP network interfaces of the M2M devices 202. The M2M gateway 204 may further send the updated information regarding the M2M devices 202 to the 3GPP network 206.

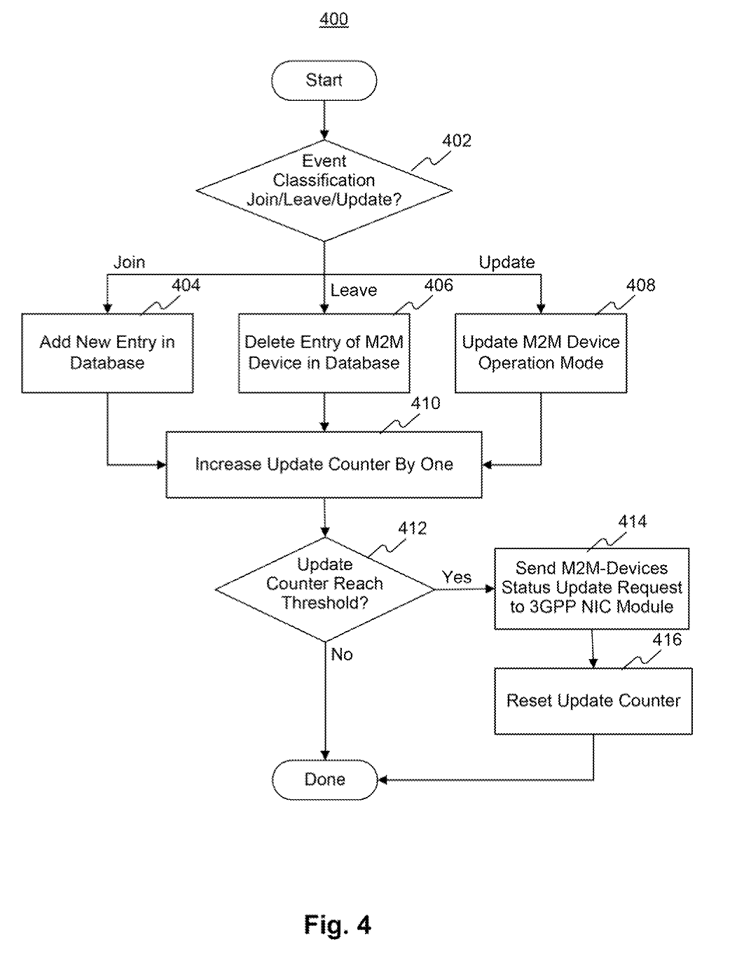

FIG. 4 shows a flowchart of a method 400 for the M2M controller unit 221 (FIG. 2B) to provide updated information regarding the M2M devices 202 (FIG. 2A) to the 3GPP NIC module 212 (FIG. 2B) in the M2M gateway 204 (FIG. 2A), according to an exemplary embodiment. Referring to FIGS. 2A, 2B, and 4, the controller 224 in the M2M controller unit 221 determines an event classification for a status change in the M2M devices 202, e.g., a join event indicating that a new M2M device joins the M2M devices 202, a leave event indicating that an existing M2M device leaves the M2M devices 202, or an update event indicating that the operation mode of any one of the M2M devices 202 changes (402).

If the controller 224 determines that a new M2M device joins the M2M devices 202 (402—Join), the controller 224 updates the database 222 by adding a new entry in the database 222, the new entry including information regarding the new M2M device, e.g., an individual identification of the new M2M device (404). If the controller 224 determines that an existing M2M device leaves the M2M devices 202 (402—Leave), the controller 224 updates the database 222 by deleting an entry corresponding to the leaving device from the database 222 (406). If the controller 224 determines that the operation mode of any one of the M2M devices 202 changes (402—Update), the controller 224 updates the database 222 by updating the entry corresponding to that device (408).

The controller 224 further increases an update counter by one (410), and determines if the update counter reaches a predetermined threshold (412), i.e., determines if a predetermined number of updates have been made to the database 222. If the controller 224 determines that the update counter has not reached the predetermined threshold (412—No), the process is complete. Otherwise (412—Yes), the controller 224 sends an M2M devices status update request to the 3GPP NIC module 212 (414), and resets the update counter (416).

The M2M enable unit 220 in the 3GPP NIC module 212 receives the M2M devices status update request from the controller 224. In addition, the M2M enable unit 220 may receive an M2M devices status update request from the 3GPP network 206. Further, the M2M gateway 204 itself may periodically send updated information regarding the M2M devices 202 to the 3GPP network 206.

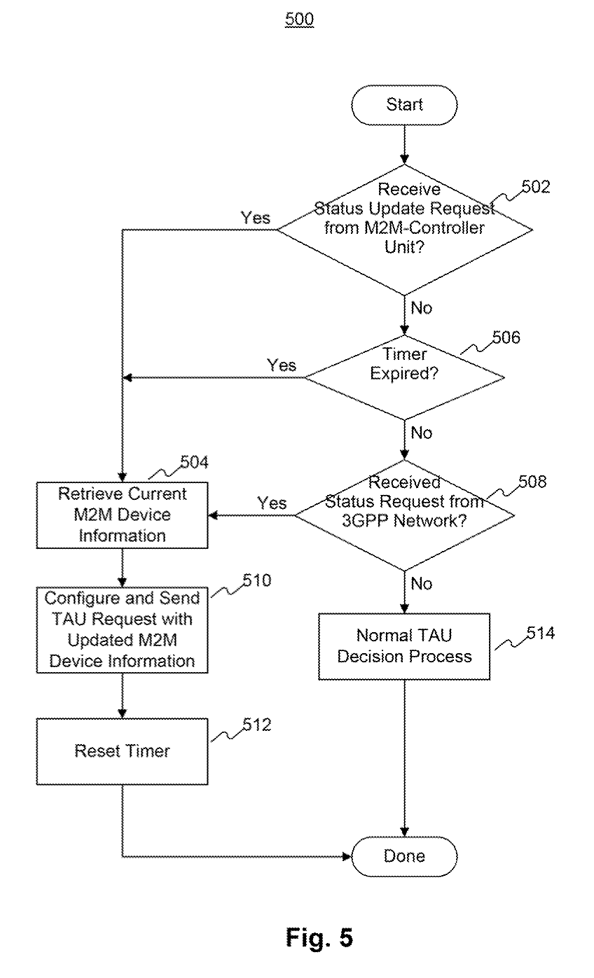

In exemplary embodiments, the M2M enable unit 220 may decide to send updated information regarding the M2M devices 202 to the 3GPP network 206 based on the above situations. FIG. 5 shows a flowchart of a decision making process 500 performed by the M2M enable unit 220, according to an exemplary embodiment.

Referring to FIGS. 2A, 2B, and 5, the M2M enable unit 220 determines if it has received an M2M devices status update request from the M2M controller unit 221 (502). If the M2M enable unit 220 determines that it receives an M2M devices status update request from the M2M controller unit 221 (502—Yes), the M2M enable unit 220 retrieves current information regarding the M2M devices 202 from the database 222 (504).

If the M2M enable unit 220 determines that it has not received an M2M devices status update request from the M2M controller unit 221 (502—No), the M2M enable unit 220 further determines if a timer used by the gateway 204 to periodically send updated information to the 3GPP network 206 has expired (506). For example, the 3GPP standard provides a Tracking Area Update (TAU) process in which a terminal in a 3GPP network may periodically update its information with the 3GPP network according to a timer. When the timer runs for a predetermined time period, the terminal initiates the TAU process to update its information with the 3GPP network.

If the M2M enable unit 220 determines that the timer has expired (506—Yes), the M2M enable unit 220 retrieves current information regarding the M2M devices 202 from the database 222 (504). Otherwise (506—No), the M2M enable unit 220 further determines if it has received an M2M devices status update request from the 3GPP network 206 (508). If the M2M enable unit 220 determines that it has received an M2M devices status update request from the 3GPP network 206 (508—Yes), the M2M enable unit 220 also retrieves current information regarding the M2M devices 202 from the database 222 (504). The M2M enable unit 220 further configures a message, referred to herein as a TAU request, including the updated information regarding the M2M devices 202, and sends the TAU request to the 3GPP network 206 (510). The M2M enable unit 220 then resets the timer (512). If the M2M enable unit 220 determines that it has not received an M2M devices status update request from the 3GPP network 206 (508—No), the M2M enable unit 220 performs a normal TAU decision process defined in the 3GPP standard (514).

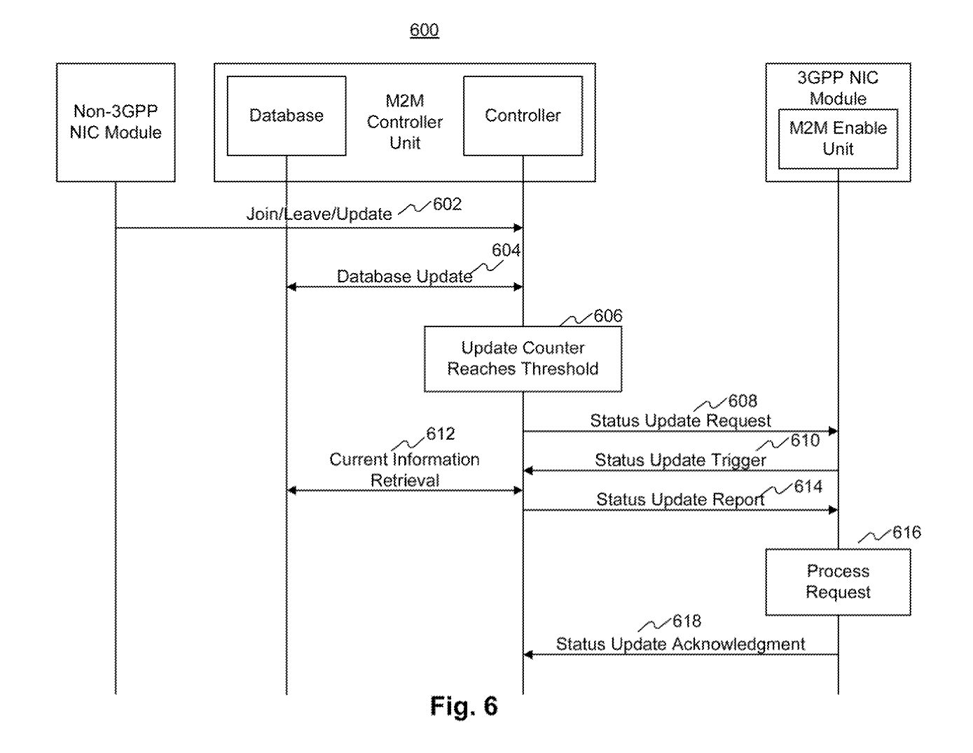

FIG. 6 illustrates a process 600 for the M2M gateway 204 (FIG. 2A) to decide on sending updated information regarding the M2M devices 202 (FIG. 2A) to the 3GPP network 206 (FIG. 2A), according to an exemplary embodiment. Referring to FIGS. 2A, 2B, and 6, the non-3GPP NIC module 210 reports to the controller 224 a status change in the M2M devices 202, e.g., a new M2M device joining the M2M devices 202, an existing M2M device leaving the M2M devices 202, or a change in the operation mode of any one of the M2M devices 202 (602). Accordingly, the controller 224 updates the database 222 (604), and increases the update counter by one, as described above. This process may be repeated until the update counter reaches the predetermined threshold (606).

The controller 224 then sends an M2M devices status update request to the M2M enable unit 220 in the 3GPP NIC module 212 (608). In response, the M2M enable unit 220 sends an M2M devices status update trigger to the controller 224 (610), and the controller 224 retrieves current information regarding the M2M devices 202 from the database 222 in response to the M2M devices status update trigger (612). The controller 224 then sends an M2M devices status update report including the current information regarding the M2M devices 202 to the M2M enable unit 220 (614). The M2M enable unit 220 further processes the M2M devices status update request by sending updated information regarding the M2M devices 202 to the 3GPP network 206 (616), and sends an M2M devices status update acknowledgement to the controller 224 (618).

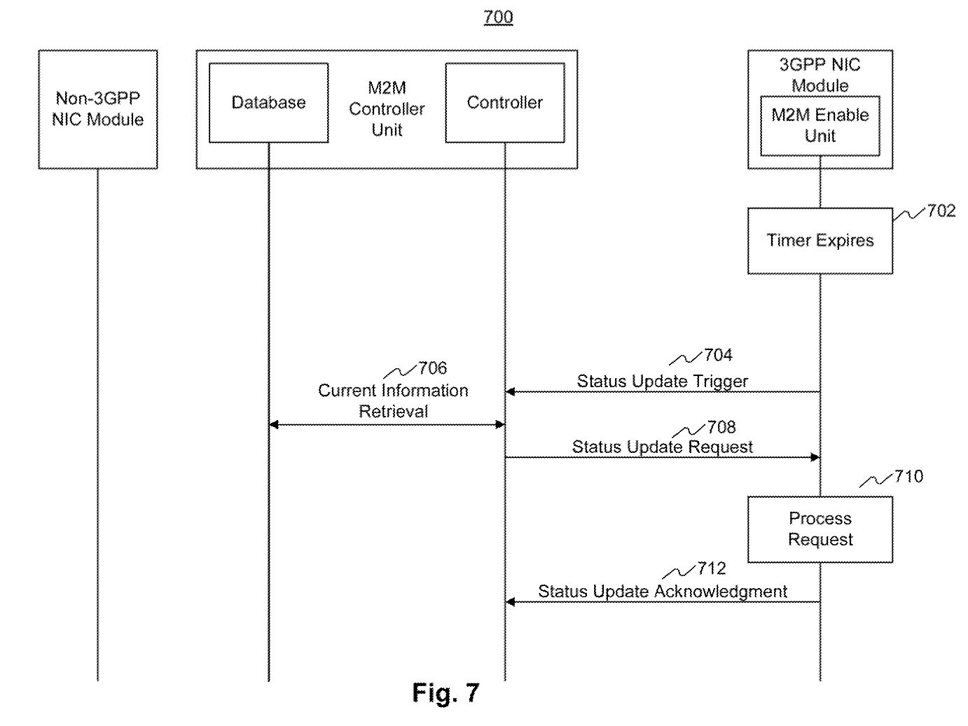

FIG. 7 illustrates a process 700 for the M2M gateway 204 (FIG. 2A) to decide on sending updated information regarding the M2M devices 202 (FIG. 2A) to the 3GPP network 206 (FIG. 2A), according to an exemplary embodiment. Referring to FIGS. 2A, 2B, and 7, when the timer used by the gateway 204 to periodically send updated information to the 3GPP network 206 expires (702), the M2M enable unit 220 sends an M2M devices status update trigger to the controller 224 (704), and the controller 224 retrieves current information regarding the M2M devices 202 from the database 222 in response to the M2M deices status update trigger (706). The controller 224 then sends an M2M devices status update report including the current information regarding the M2M devices 202 to the M2M enable unit 220 (708). The M2M enable unit 220 further processes the M2M devices status update request by sending updated information regarding the M2M devices 202 to the 3GPP network 206 (710), and sends an M2M devices status update acknowledgement to the controller 224 (712).

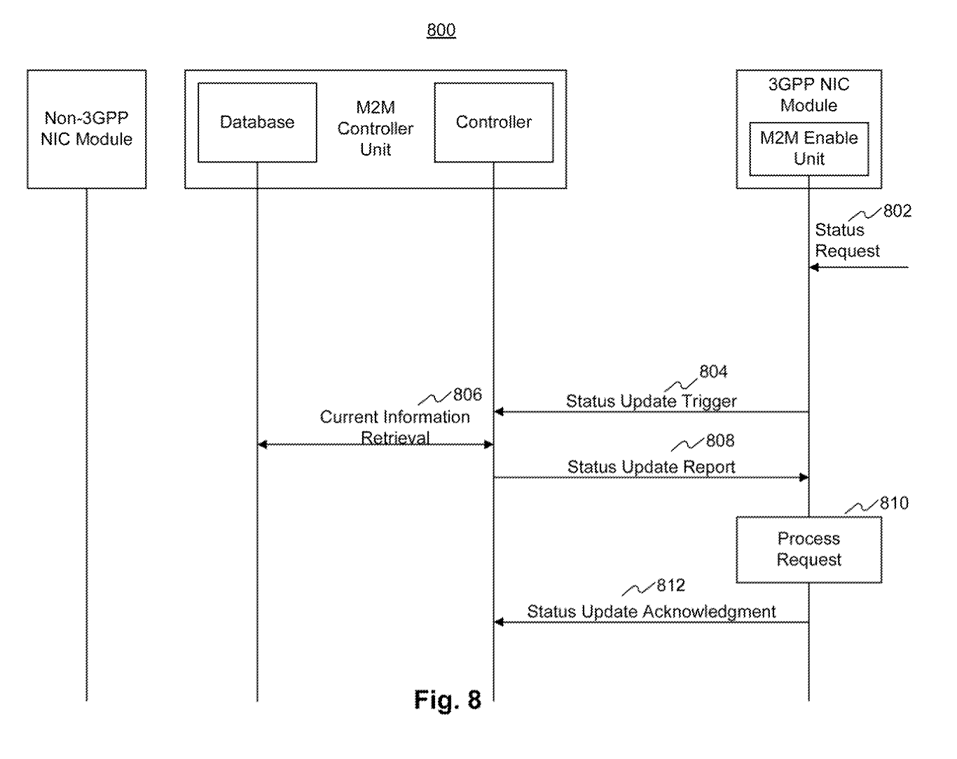

FIG. 8 illustrates a process 800 for the M2M gateway 204 (FIG. 2A) to decide on sending updated information regarding the M2M devices 202 (FIG. 2A) to the 3GPP network 206 (FIG. 2A), according to an exemplary embodiment. Referring to FIGS. 2A, 2B, and 8, when the M2M enable unit 220 receives an M2M devices status request from the 3GPP network 206 (802), the M2M enable unit 220 sends an M2M devices status update trigger to the controller 224 (804), and the controller 224 retrieves current information regarding the M2M devices 202 from the database 222 in response to the M2M devices status update trigger (806). The controller 224 then sends an M2M devices status update report including the updated information regarding the M2M devices 202 to the M2M enable unit 220 (808). The M2M enable unit 220 further processes the M2M devices status update request by sending updated information regarding the M2M devices 202 to the 3GPP network 206 (810), and sends an M2M devices status update acknowledgement to the controller 224 (812).

As a result, the M2M gateway 204 may periodically, or non-periodically such as based on a condition which may not occur at periodic intervals, send updated information regarding the M2M devices 202 to the 3GPP network 206. As described above, the 3GPP standard provides a Tracking Area Update (TAU) process in which a terminal in a 3GPP network periodically updates its information with the 3GPP network according to a timer and defined conditions. In the exemplary embodiment, the M2M gateway 204 periodically or non-periodically sends updated information regarding the M2M devices 202 to the 3GPP network 206 based on the TAU process provided in the 3GPP standard.

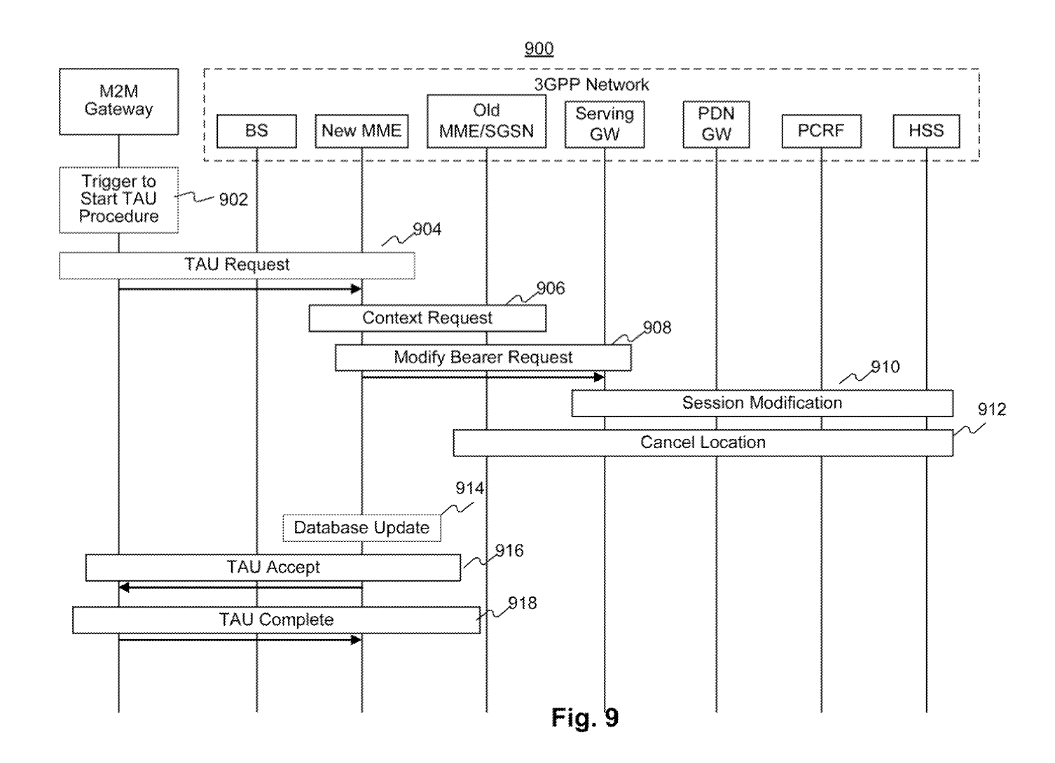

FIG. 9 illustrates a process 900 for the M2M gateway 204 (FIG. 2A) to send updated information regarding the M2M devices 202 (FIG. 2A) to the 3GPP network 206 (FIG. 2A) based on the TAU process, according to an exemplary embodiment. Referring to FIGS. 2A and 9, the M2M gateway 204 is triggered, or decides, to start the process 900 as described in FIG. 6, 7, or 8 (902). The M2M gateway 204 sends a TAU request to the new MME through the base station (904). The TAU request includes updated information regarding the M2M devices 202, e.g., one or more group identifications for the M2M devices 202 as one or more groups, respectively, a number of the M2M devices 202 in each of the groups and/or connected to the M2M gateway 204, a list of individual identifications of the respective M2M devices 202, or M2M features.

Next, the new MME sends a context request to the old MME/SGSN, to request context information regarding the M2M gateway 204 (906), and further sends a modify-bearer request to the serving GW to modify evolved packet system (EPS) bearers (908). An EPS bearer is a transmission channel through an EPS packet network which may have a defined set of data transmission characteristics such as quality of service data rate and flow control. Accordingly, the EPS bearers and, hence, the current communication session are modified (910), and the HSS sends a cancel-location message to the old MME (912), to ask the old MME to delete all bearer resources of the M2M gateway 204 (912).

Next, the new MME updates its database to include the updated information regarding the M2M devices 202 (914). The new MME further sends a TAU-accept message to the M2M gateway 204 to indicate an acceptance of the TAU request (916), and the M2M gateway 204 responds to indicate completion of the information update for the M2M devices 202 (918).

While embodiments have been described based on the 3GPP network, the invention is not so limited. It may be practiced with equal effectiveness with other wireless networks operating in accordance with a communication standard, such as a wireless network operating in accordance with a Worldwide Interoperability for Microwave Access (WiMAX) standard.

Other embodiments of the invention will be apparent to those skilled in the art from consideration of the specification and practice of the embodiments disclosed herein. The scope of the invention is intended to cover any variations, uses, or adaptations of the invention following the general principles thereof and including such departures from the present disclosure as come within known or customary practice in the art. It is intended that the specification and examples be considered as exemplary only, with a true scope and spirit of the invention being indicated by the following claims.

It will be appreciated that the present invention is not limited to the exact construction that has been described above and illustrated in the accompanying drawings, and that various modifications and changes can be made without departing from the scope thereof. It is intended that the scope of the invention only be limited by the appended claims.

What is claimed is:

1. Apparatus for coupling one or more machine-to-machine (M2M) devices to a wireless network, comprising:
a first network interface controller (NIC) module configured to communicate with the M2M devices;
an M2M controller unit coupled to the first NIC module, the M2M controller unit including a database and a controller, the controller being configured to store information regarding the M2M devices in the database and to retrieve information regarding the M2M devices from the database; and
a second NIC module coupled to the M2M controller unit, the second NIC module including an M2M enable unit configured to send the information retrieved by the controller to the wireless network.

2. The apparatus of claim 1, wherein the wireless network operates according to a communication standard which is a 3rd Generation Partnership Project (3GPP) standard.

3. The apparatus of claim 2, wherein the information retrieved by the controller includes initial information regarding the M2M devices, the M2M enable unit being configured to send the initial information regarding the M2M devices to the wireless network based on an initial attach process provided in the 3GPP standard.

4. The apparatus of claim 1, being configured to enable the wireless network to update a database of the wireless network with initial information regarding the M2M devices.

5. The apparatus of claim 2, wherein the information retrieved by the controller includes updated information regarding the M2M devices, the M2M enable unit being configured to send the updated information regarding the M2M devices to the wireless network based on a Tracking Area Update (TAU) process provided in the 3GPP standard.

6. The apparatus of claim 5, wherein the M2M enable unit is configured to periodically or non-periodically send the updated information regarding the M2M devices to the wireless network.

7. The apparatus of claim 1, being configured to enable the wireless network to update a database of the wireless network with updated information regarding the M2M devices.

8. The apparatus of claim 1, wherein the first NIC module is configured to communicate with the M2M devices using one or more of a WiFi interface, a Bluetooth interface, a Zigbee interface, and a radio-frequency identification (RFID) interface.

9. The apparatus of claim 1, wherein the controller stores the information regarding the M2M devices in the database, the stored information including at least one of one or more group identifications of the M2M devices as one or more groups, respectively, a number of the M2M devices in each of the groups, a list of individual identifications of the respective M2M devices, and an operation mode of each of the M2M devices.

10. The apparatus of claim 1, wherein when a new M2M device is added into the M2M devices, the controller is configured to update the database by adding into the database a new entry including information regarding the new M2M device.

11. The apparatus of claim 1, wherein when an existing M2M device is removed from the M2M devices, the controller is configured to update the database by deleting from the database an entry corresponding to the removed M2M device.

12. The apparatus of claim 1, wherein when an operation mode of one of the M2M devices changes, the controller is configured to update the database by updating an entry corresponding to that one of the M2M devices.

13. The apparatus of claim 1, wherein the second NIC module enables control and monitoring of the M2M devices through the wireless network.

14. A method for a gateway to couple one or more machine-to-machine (M2M) devices to a wireless network, comprising:
communicating with the M2M devices;
storing information regarding the M2M devices in a database and retrieving information regarding the M2M devices from the database; and
sending the retrieved information to the wireless network.

15. The method of claim 14, wherein the retrieved information includes initial information regarding the M2M devices, the sending comprising:
sending the initial information regarding the M2M devices to the wireless network based on an initial attach process provided in a 3GPP standard.

16. The method of claim 14, further comprising:
enabling the wireless network to update a database of the wireless network with initial information regarding the M2M devices.

17. The method of claim 14, wherein the retrieved information includes updated information regarding the M2M devices, the sending comprising:
sending the updated information regarding the M2M devices to the wireless network based on a Tracking Area Update (TAU) process provided in the 3GPP standard.

18. The method of claim 17, wherein sending the updated information comprises:
periodically or non-periodically sending the updated information regarding the M2M devices to the wireless network.

19. The method of claim 14, further comprising:
enabling the wireless network to update a database of the wireless network with updated information regarding the M2M devices.

20. The method of claim 14, wherein the communicating comprises:
communicating with the M2M devices using one or more of a WiFi interface, a Bluetooth interface, a Zigbee interface, and a radio-frequency identification (RFID) interface.

21. The method of claim 14, wherein the storing comprises:
storing the information regarding the M2M devices in the database, the stored information including at least one of one or more group identifications of the M2M devices as one or more groups, respectively, a number of the M2M devices in each of the groups, a list of individual identifications of the respective M2M devices, and an operation mode of each of the M2M devices.

22. The method of claim 14, wherein the sending comprises:
sending the retrieved information to the wireless network, to enable control and monitoring of the M2M devices through the wireless network.
